(19) United States
(12) Patent Application Publication
(10) Pub. No.: US 2007/0000603 A1
(43) Pub. Date: Jan. 4, 2007

(54) METHOD OF FORMING AT LEAST ONE CONTINUOUS LINE OF VISCOUS MATERIAL BETWEEN TWO COMPONENTS OF AN ELECTRONIC ASSEMBLY

(75) Inventors: Alec J. Babiarz, Encinitas, CA (UA); Kristina Babiarz, Encinitas, CA (US); Liang Fang, San Diego, CA (US); Erik Fiske, Carlsbad, CA (US); Christopher L. Giusti, San Marcos, CA (US); Horatio Quinones, Carlsbad, CA (US); Floriana Suriawidjaja, Carlsbad, CA (US); Thomas L. Ratledge, San Marcos, CA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/424,102

(22) Filed: Jun. 14, 2006

Related U.S. Application Data
(60) Provisional application No. 60/696,386, filed on Jul. 1, 2005.

(51) Int. Cl. B05D 5/12; B05D 3/12

(52) U.S. Cl. 156/291; 427/96.1; 427/355; 427/256

(57) ABSTRACT

A method is provided for forming at least one continuous line of viscous material between two components of an electronic assembly forming two substrates. The method includes the steps of depositing a plurality of spaced apart dots of the viscous material onto a surface of a first one of the substrates and bringing a second one of the substrates into contact with the dots causing the dots to merge together to form at least one continuous line of the viscous material between the two substrates.

### CROSS REFERENCE

This application claims the priority benefit of U.S. Provisional Patent Application Ser. No. 60/696,386, “METHOD OF FORMING AT LEAST ONE CONTINUOUS LINE OF VISCOUS MATERIAL BETWEEN TWO COMPONENTS OF AN ELECTRONIC ASSEMBLY”, filed Jul. 1, 2005, which is expressly incorporated by reference herein in its entirety.

### FIELD OF THE INVENTION

The present invention relates to a method of applying a viscous material that will be located between two components of an electronic assembly.

### BACKGROUND

During the manufacture of Organic Light- Emitting Diode (OLED) Display Panels, which are electronic assemblies, it is necessary to dispense small amounts of viscous material, such as an ultraviolet (UV)-curable resin in one or more rectangular shapes onto a glass substrate and then to place a second substrate on top of the resin so that the resin forms a seal, between the two glass substrates. The seal between the substrates must limit the diffusion of oxygen, water or other unwanted substances into the area where the electronic circuitry was vapor-deposited onto at least one of the glass substrates. As known in the art, the circuitry includes light emitting diodes, comprised of organic materials, as well as various dyes and phosphors and electrical connections between circuitry made of material such as indium tin oxide. Water, oxygen and other unwanted substances adversely affect the foregoing materials.

OLED Display Panels have a variety of applications such as cellular phones, MP3 players, motor vehicle stereos, and PDA's, that can require square or rectangular display panels. With typical manufacturing processes, relatively large arrays of display panels are created on one relatively large piece of glass substrate. The individual display panels are cut out after a lamination process that bonded the two glass substrates together with the UV-curable resin. Each individual display panel in the array requires a seal formed around the perimeter of the display panel. It is important to be able to form the seals with ever-decreasing inside radii at the corners of the rectangular or square patterns to avoid losing usable display panel surface area in the corners, as may be appreciated by one skilled in the art. Conventional seals are typically made using a needle dispensing process that applies continuous lines of the viscous material to form the seal.

Needle dispensing the patterns of viscous material has been used but presents certain challenges. For example, the needle dispensing quality is very dependent on the speed of the machine moving the needle over the substrate. If the velocity of the viscous material extruding from the needle is slower than the velocity of the needle over the substrate, the viscous material is stretched, which results in poor wetting and line quality. If the velocity of the extruded fluid is faster than the velocity of the needle across the substrate, excess viscous material is “plowed” onto the substrate, again producing undesirable results.

Creating sharp corners in rectangular seals with viscous material has proved to be problematic. The change in velocity of the needle at the corner leads to excess material deposited in the corner. When this happens and the two glass substrates are squeezed together during the laminating process, the excess seal material may not form a well-defined inside radius. Instead, the inside corner radius is large resulting in a loss of OLED Display Panel surface area.

Another line quality problem associated with needle dispensing of continuous lines concerns the vertical spacing, or gap, between the needle tip and substrate, and the manufacturing tolerances in the “flatness” of the substrate and any fixture on which the substrate rests. If the gap gets too high, the line will not be straight or consistent; if the gap is too small, the needle may hit the substrate or the fluid flow will be blocked. The typical inside diameter for needles used in this process is about 0.26 mm and the optimum gap between the needle tip and the substrate is about one half of the inside diameter of the needle, or 0.13 mm in this case. However, the glass substrate on which the viscous material will be applied can have vertical surface variations of about plus or minus 0.50 mm to 1.0 mm. Considering a substrate with a surface area of about 1.0 m^{2,} that is used to manufacture a relatively large number of individual OLED Display Panels, the height variations can be greater than 1 mm. Accordingly, a particular needle height setting that establishes the initial needle gap, may be acceptable to manufacture only a few of the display panels. Therefore it is likely that the needle height setting must be changed many times as the needle moves over the broad expanse of the substrate. Each reset of the height setting takes time and slows the manufacturing process.

Jetting dots of viscous material onto a substrate is an alternative to needle dispensing, as known in the art. Typically jets operate with a gap of 1 mm plus or minus 1 mm, therefore jetting requires less height corrections which provides faster processing . Dots may be jetted in overlapping relationship with one another to form a line or they may be spaced apart from one another. Jetting is also faster than needle dispensing due to flow considerations. Although the jetting nozzle and needle have comparable inside diameters, the needle is typically substantially longer than the jetting nozzle. Accordingly, as may be appreciated by one of ordinary skill in the art, an unacceptably high pressure would be required to force an equivalent amount of viscous material out of the needle, as compared to the jetting nozzle, due to the relatively longer length of the needle.

In view of the foregoing, there is a continuing need for an improved method of applying viscous material between two components of an electronic assembly.

### SUMMARY

According to a first aspect of the present invention a method of forming at least one continuous line of viscous material between two components of an electronic assembly forming two substrates is provided. The method includes the steps of depositing a plurality of spaced apart dots of the viscous material onto a surface of a first one of the substrates and bringing a second one of the substrates into contact with the dots causing the dots to merge together to form at least one continuous line of viscous material between the two substrates.

The step of depositing the dots can comprise jetting, stenciling, pin transferring or needle dispensing the dots onto the surface of the first one of the substrates.

The method can further comprise the step of selecting a predetermined spacing between adjacent ones of the dots on the surface of the first one of the substrates so that the viscous material merges together during the step of bringing the second one of the substrates into contact with the viscous material to create at least one continuous line of the viscous material. The line of viscous material that is formed can have a substantially uniform width.

The method can also include the steps of forming first and second continuous lines of the viscous material between the two substrates, with the lines being disposed substantially perpendicular to one another. A substantially uniform inside fillet radius can be formed between the two lines of viscous material, and each line can have a substantially uniform width. The first line can be formed by depositing a first plurality of spaced apart and aligned dots onto the first one of the substrates and bringing the second one of the substrates into contact with the dots, causing them to merge together. Similarly, the second line can be formed by depositing a second plurality of spaced apart and aligned dots onto the first substrate.

According to a second aspect of the present invention, a method is provided of forming a pattern of viscous material between two components of an electronic assembly forming two substrates, with the pattern including a plurality of continuous line segments of the viscous material and corners at each interconnected pair of the line segments. The method comprises the step of depositing a pattern of spaced apart dots of viscous material onto a surface of one of the substrates, with the pattern of dots including multiple sets of aligned ones of the dots and a plurality of corners, each of the corners being formed by an adjacent pair of the sets of dots. The number of sets of aligned dots corresponds to the number of continuous line segments of the pattern of viscous material to be formed. The step of depositing comprises selecting a predetermined size of individual ones of the dots to achieve a substantially uniform width for each of the continuous line segments of the pattern of viscous material to be formed and selecting a pair of end points for each of the sets of dots to be deposited. The step of depositing further comprises leaving a gap at each corner of the pattern of dots to be deposited between one of the end points of a first one of the adjacent pair of sets of dots and an adjacent one of the end points of a second one of the adjacent pair of sets of dots, for each pair of the sets of dots. The method further comprises bringing a second one of the substrates into contact with the dots to form a pattern of continuous line segments of the viscous material.

The method can further comprise programming a controller with a pattern of dots to be dispensed and laminating the two substrates in a pattern of viscous material disposed between the substrates.

The method can further comprise determining if the line segments of a pattern of viscous material are interconnected with one another to form the corners of the pattern, with the corners having inside radii, measuring the radii and adjusting the gaps within the pattern of dots as required to achieve the desired pattern of viscous material. The gaps can be reduced if the adjacent pairs of line segments do not join to form corners within the pattern of viscous material and the gaps can be increased if the radii are too large.

According to another embodiment, the method further comprises measuring the mass flow rate of the dots of viscous material being deposited, calculating the total number of dots required within the pattern to maintain the total weight of dots within the pattern and adjusting the number and distribution of dots within the pattern if required to maintain the total weight of dots within the pattern. The method can further comprise decreasing the number of dots within at least some of the sets of dots, in proportion to the distances between the end points of each of the sets of dots, starting with the set of dots having the greatest distance between the end points, if the number of dots required to maintain the total weight of dots has decreased relative to the number of dots required previously. Similarly, the method can comprise increasing the number of dots within at least some of the sets of dots, in the same manner, if the number of dots required to maintain the total weight of dots to be deposited has increased relative to the previously required number of dots.

The method can further comprise programming a controller with the pattern of dots to be deposited and laminating the two substrates in a pattern of viscous material disposed between the substrates.

According to a third aspect of the present invention, a method is provided of forming a seal of viscous material between two components of an electronic assembly forming two substrates, with the method comprising the step of depositing a plurality of dots of the viscous material onto a surface of a first one of the substrates so that each of the dots is spaced apart from every other dot. The method further comprises bringing a second one of the substrates into contact with the dots, with the step further comprising: forming at least one continuous line of the viscous material from the plurality of dots; surrounding an interior area on each of the substrates with the at least one continuous line of the viscous material to create a seal of the viscous material between the two substrates.

In one embodiment, the method comprises the step of depositing first, second, third and fourth pluralities of dots of the viscous material onto a surface of a first one of the substrates so that each of the dots, of the first, second, third and fourth pluralities of dots, are spaced apart from every other dot. The method further comprises the step of bringing a second substrate into contact with the dots causing the material to merge together. The method also comprises the steps of forming first, second, third and fourth continuous lines of the fluid, with the first and second lines being spaced apart from one another and substantially parallel to one another. The third and fourth lines are substantially parallel to one another and substantially perpendicular to the first and second lines. The method further comprises the step of interconnecting the first, second, third and fourth lines with one another to create a substantially parallelogram-shaped perimeter of the viscous material surrounding an interior space within the perimeter.

Forming a seal of viscous material between two components of an electronic assembly forming two substrates according to the method of the present invention can result in an economy of material, and hence reduced cost, as well as improved line quality relative to prior methods of creating seals for electronic assemblies such as OLED Display Panels. For those embodiments where the viscous material is jetted onto a substrate, another advantage is increased line speed and therefore reduced cost, compared to prior needle dispensing of continuous lines of viscous material. Jetting line speeds can be three times faster than equivalent needle dispensing methods due to minimizing dispensing height corrections and faster fluid flow from the jet nozzle.

### BRIEF DESCRIPTION OF THE DRAWINGS

These and other features, aspects, and advantages of the present invention will become better understood with regard to the following description, appended claims and accompanying drawings wherein:

FIG. 1A is a schematic representation of a dispensing system which can be used in conjunction with the method of the present invention, with the system shown in a calibration mode;

FIG. 1B is a schematic representation of the dispensing system shown in FIG. 1A, but with the system in a production mode;

FIG. 2A is a plan view of a plurality of dots of viscous material deposited onto a substrate, with the dots spaced apart by a first spacing;

FIG. 2B is a plan view of the viscous material shown in FIG. 2A after a second substrate has contacted the viscous material;

FIG. 3A is a plan view of a plurality of dots of viscous material deposited onto a substrate, with the dots spaced apart by a second spacing;

FIG. 3B is a plan view of the viscous material shown in FIG. 3A after a second substrate has contacted the viscous material;

FIG. 4A is a plan view of a plurality of dots of viscous material deposited onto a substrate, with the dots spaced apart by a third spacing;

FIG. 4B is a plan view of the viscous material shown in FIG. 4A after a second substrate has contacted the viscous material;

FIG. 5A is a plan view of a plurality of dots of viscous material deposited onto a substrate, with the dots spaced apart by a fourth spacing;

FIG. 5B is a plan view of the viscous material shown in FIG. 5A after a second substrate has contacted the viscous material;

FIG. 5C is a side elevation view of the line of the viscous material shown in FIG. 5B disposed between two substrates;

FIG. 6A is a plan view of first and second pluralities of spaced apart dots of viscous material deposited onto a substrate;

FIG. 6B is a plan view of two intersecting lines of viscous material formed after a second substrate has contacted the first and second pluralities of dots illustrated in FIG. 6A;

FIG. 7A is a plan view of first, second, third and fourth pluralities of spaced apart dots of viscous material deposited onto a substrate;

FIG. 7B is a plan view of four lines of viscous material interconnected with one another that are formed after a second substrate has contacted the first, second, third and fourth pluralities of dots illustrated in FIG. 7A; and

FIG. 7C is a side elevation view of the seal of viscous material shown in FIG. 7B disposed between two substrates.

FIG. 8 is a flow chart representation of method steps according to the principles of the present invention regarding the inside radius at a corner of two line segments of viscous material;

FIG. 9A is a plan view of a dispensed pattern of spaced apart dots of viscous material deposited onto a substrate, prior to lamination, having four sets of dots;

FIG. 9B is a plan view of a pattern of viscous material that is formed after the sets of dots shown in FIG. 9A are contacted with a second substrate;

FIG. 10 is a flow chart representation of method steps according to the principles of the present invention directed to the adjustment of a dispensed pattern of dots of viscous material to achieve the desired joining of line segments within the pattern and to achieve desirable inside radii at the corners between each pair of line segments;

FIG. 11 is a plan view similar to FIG. 9A, but with the distribution of dots in the pattern revised to adjust for increased size and mass of the individual dots of viscous material dispensed;

FIG. 12A is a plan view of a dispensed pattern of spaced apart dots of viscous material deposited onto a substrate, prior to lamination, having five sets of dots; and

FIG. 12B is a plan view similar to FIG. 1 OA, but with the distribution of dots in the pattern revised to adjust for increased size and mass of the individual dots of viscous material dispensed.

### DETAILED DESCRIPTION

The present invention provides a method for forming at least one continuous line of viscous material, such as a UV-curable resin, between two substrates such as two components of an electronic assembly. The method can be used to form straight lines, curved lines or a combination of straight and curved lines between the two components. In one application, the method of the present invention can be used to form a seal of viscous material between the two substrates, with the seal having any shape formed by straight or curved lines alone or any combination of straight and curved lines.

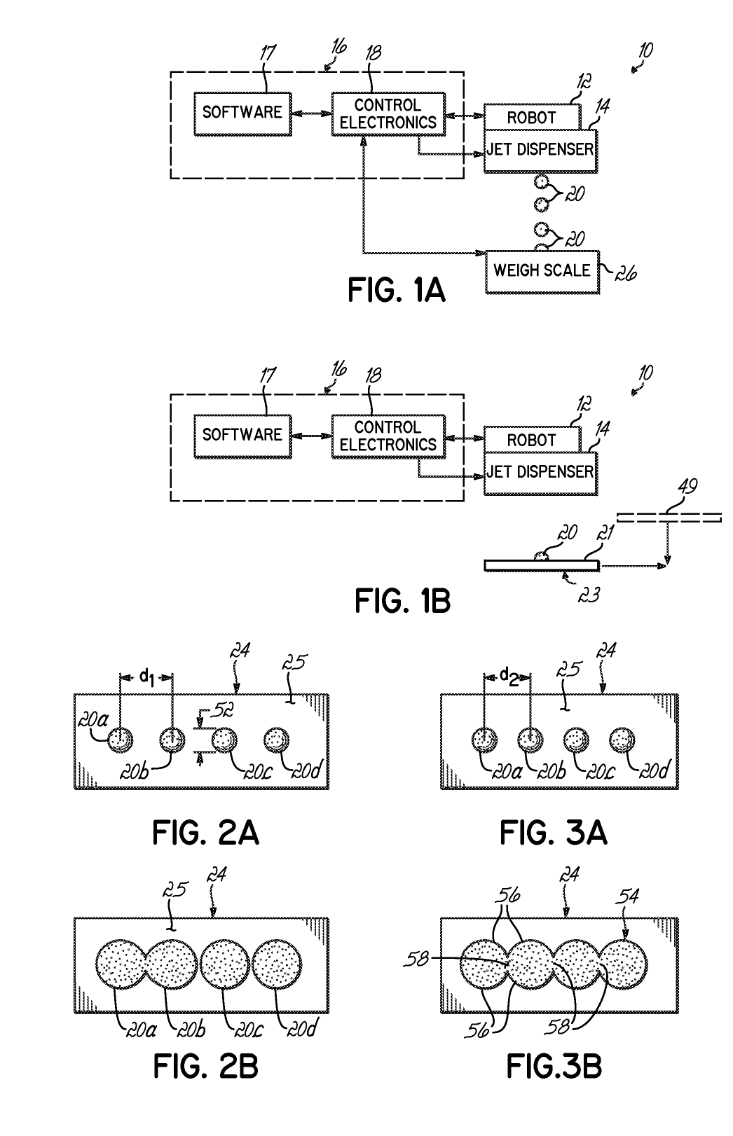

The method of the present invention can be practiced using a jet-dispensing system, such as fluid dispensing system 10 illustrated in FIGS. 1A and 1B, or by using other devices and methodology, such as needle dispensing, pin transfer and stenciling that are capable of depositing discrete amounts of viscous material onto a substrate in spaced apart relationship with one another.

The method of the present invention includes the step of depositing a plurality of discrete amounts of viscous material 20, such as a UV-curable resin, onto a surface of a first substrate, such as a surface 21 of the substrate 23 shown in FIG. 1B. Substrate 23 can be a component of an electronic assembly, having various applications such as in the manufacture of an OLED Display Panel. The discrete amounts of viscous material can have three-dimensional shapes, which, when viewed from above, appear as “dots” as shown in the Figures herein, as well as any other three-dimensional shape depositable with jet dispensing systems, needle dispensing systems, pin transfer systems and stenciling systems, and any other devices and methodology known in the art. However, for the sake of brevity and simplicity, all such shapes are embraced by the term “dots.” When a jet-dispensing system such as system 10 is used, the step of depositing a plurality of dots onto a surface of a first substrate comprises the step of jetting the dots onto the surface of the first substrate.

Referring now to the drawings, FIG. 1A schematically illustrates the fluid dispensing system 10 in a calibration mode, while FIG. 1B schematically illustrates system 10 in a production mode. Fluid dispensing system 10 includes a conventional robot 12 and a jet dispenser 14 mechanically coupled to robot 12 for movement along, and rotation about, multiple axes. System 10 further includes a controller 16 having software 17 and control electronics 18 electrically coupled to one another for communication with one another. The controller can be a programmable logic controller (PLC) or other microprocessor based controller, such as a computer, or other conventional control devices capable of carrying out the functions described herein as it will be understood by those of ordinary skill in the art.

The jet dispenser 14 includes an on/off control (not shown) which, in the illustrative embodiment, is a non-contact dispenser valve specifically designed for dispensing minute amounts of viscous material. One configuration that can be used for the dispenser valve is shown and described in U.S. Pat. No. 5,747,102, assigned to the assignee of the present invention, which is expressly incorporated by reference herein in its entirety.

The jet dispenser 14 works in conjunction with the robot 12 to dispense dots onto a substrate, such as substrate 23, as follows. During an initial calibration mode, system 10 is configured as shown in FIG. 1A, with a weigh scale 26 electrically coupled with the control electronics 18. Once beginning and end points of desired lines are established in the software 17, the jet dispenser 14 is commanded by the control electronics 18 to dispense, or jet, an even number of dots, or dots by time increments, or by spacing or groups of dots by space or time similar to a dashed line or by total mass of the viscous material in the line from beginning to end.

When the viscous material dispensed is specified by mass via the software, a specific number of equally spaced dots 20 are jetted based on a software calculation of total mass specified for the line divided by the average mass per dot 20. The weigh scale 26 is used to determine the average mass of each dot 20 during calibration of the system 10. The software 17 commands the electronic controller to move the robot 12 and the jet dispenser 14 over the weigh scale 26. The jet dispenser is commanded to jet a software-specified number of dots 20 into a calibration container (not shown) on the weigh scale 26. After subtracting the tare weight of the container, the software 17 calculates the mass per dot 20 by dividing the mass jetted into the calibration container on the weigh scale 26 by the number of dots 20 jetted into the calibration container.

After the calibration of system 10 has been completed, the system 10 is configured to deposit dots 20 of viscous material onto a substrate, such as substrate 23, as shown in FIG. 1B. With system 10 configured as shown in FIG. 1B, the dots, 20, are deposited onto substrate 23 with the required predetermined spacing and described pattern.

The method of the present invention further includes the step of bringing a second substrate that can be a component of an electronic assembly, such as component 49 shown in phantom line in FIG. 1B, into contact with the dots, such as dots 20a, 20b, 20c and 20d (FIGS. 2A, 3A, 4A, 5A and 6A), to create at least one continuous line of viscous material between the two components 23 and 49, as subsequently discussed in greater detail with regard to Examples 1-5. Components 23 and 49 can be sheets of glass, with at least one of the components 23 and 49 having electronic circuitry vapor-deposited thereon, in a known manner. The mechanism for moving component 49 into contact with the dots deposited onto component 23, is well known in the art and will not be discussed herein.

The method of the present invention further comprises the step of selecting the spacing between the adjacent ones of the dots, such as dots 20, on the surface 21 of component 23 such that the discrete amounts 20 of viscous material merge together to form a continuous line having a substantially uniform thickness, when component 49 is brought into contact with the discrete amounts 20 of viscous material. During or after the process of bringing components 23 and 49 into contact with one another, components 23 and 29, and the viscous material disposed therebetween are laminated in a manner known in the art. The equipment used to accomplish this lamination is also known in the art and will not be discussed herein.

The method of the present invention, including the spacing between the dots, may be further appreciated with reference to Examples 1-5 that have been conducted. The results of Examples 1-5 are illustrated in FIGS. 2A-6A, 2B-6B and 5C. In Examples 1-5, each of the dots 20 of viscous material had a nominal diameter 52 of about 0.5 mm and the viscous material that was dispensed was a UV-curable resin. The viscosity of the UV-curable resin was about 30K to 40K centipoise. However, the method of the present invention can be used with materials having an extremely wide range of viscosities ranging from 1.0 centipoise to about 1 M centipoise.

In each of the Examples 1-5, a plurality of discrete dots 20 was dispensed onto a surface 25 of a glass substrate 24. Then a second glass substrate 50 was brought into contact with the dots 20. Substrate 50 is omitted from FIGS. 2A-6A and 2B-6B for purposes of clarity of illustration but is shown in FIG. 5C. The series of illustrations shown in FIGS. 2A-5A illustrate dots 20 prior to the lamination process, when component 50 was brought into contact with the dots 20, and the components 50 and 24, as well as the dots 20 were laminated. In each of the FIGS. 2A-5A, only four of the dots 20 are shown, designated as dots 20a, 20b, 20c and 20d, for purposes of illustration.

### Example 1

The results of Example 1 are illustrated in FIGS. 2A and 2B. In Example 1, each adjacent pair of dots 20, such as dots 20a and 20b were spaced apart from one another by a first distance d₁, shown in FIG. 2A. Distance d₁ had a value of about 1.02 mm. As shown in FIG. 2B, after lamination, the dots 20b, 20c, and 20d were still spaced apart from one another, whereas dots 20a and 20b were somewhat interlinked. Nevertheless, the result was unacceptable as no continuous line of viscous material was formed. Accordingly, water and oxygen and other unwanted material could diffuse through the spaces between dots 20b and 20c and between dots 20c and 20d.

### Example 2

The results of Example 2 are illustrated in FIGS. 3A and 3B. In Example 2, the spacing between adjacent ones of the dots 20 was reduced, such that the spacing d₂ shown in FIG. 3A was about 0.89 mm between adjacent ones of the dots, such as dots 20a and 20b. In this case, after lamination, each of the dots 20a, 20b, 20c and 20d were interlinked with one another, as shown in FIG. 3B, and formed a continuous line 54 of the viscous material. However, as shown in FIG. 3B, line 54 did not have a uniform width. Instead, line 54 included a plurality of cusps or arcuate portions 56, with the line 54 having a relatively narrow width, indicated at 58, extending between opposite sides of the line 54 in the areas of the intersections of adjacent ones of the cusps 56. This was not an acceptable result, since the viscous material is used to form a seal, typically having a square or rectangular shape, around the perimeter of a display panel such as an OLED display panel. This is because water, oxygen and other unwanted substances could diffuse through the relatively small areas of width 58 of the viscous material, compromising the integrity of the seal formed by the viscous material, and adversely affecting various materials of the OLED display panel.

### Example 3

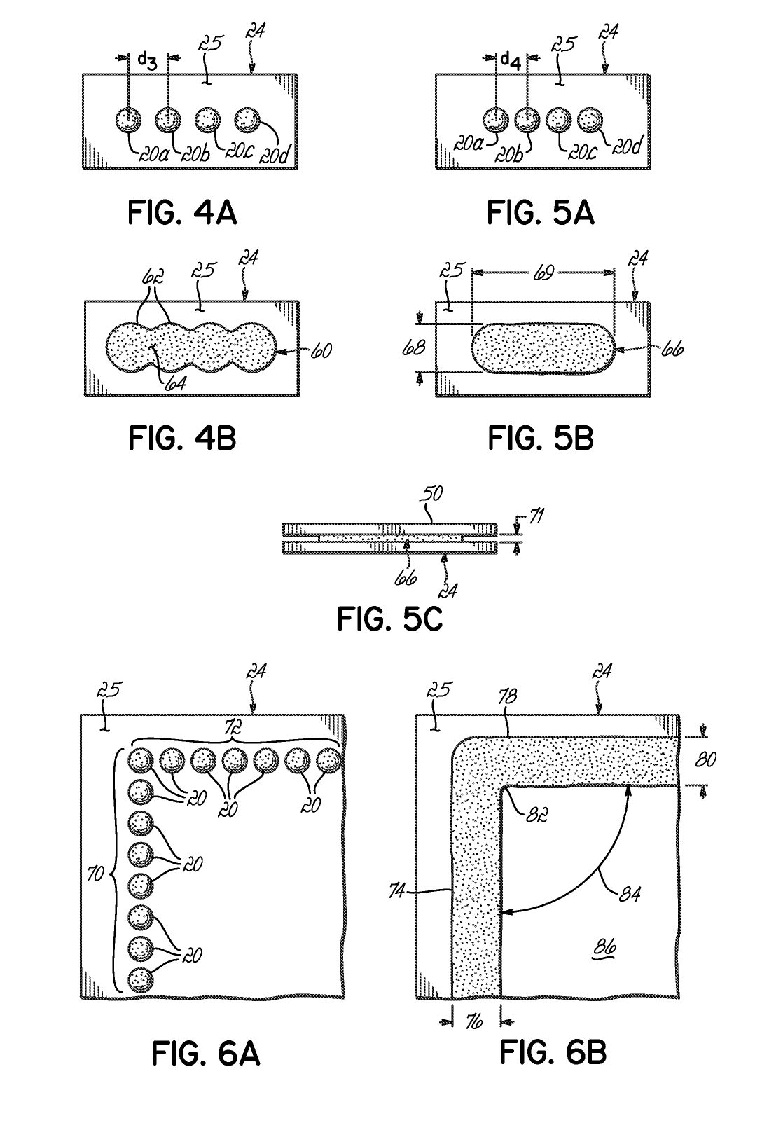

The results of Example 3 are illustrated in FIGS. 4A and 4B. In Example 3, the plurality of dots 20a, 20b, 20c and 20d were separated by yet another distance d₃, shown in FIG. 4A, between the centers of adjacent ones of the dots, such as dots 20a and 20b. Distance d₃ had a value of about 0.76 mm, which was less than spacings d₂ and d₁ shown in FIGS. 3A and 2A, respectively. FIG. 4B illustrates the viscous material on surface 25 of substrate 24 after the lamination process, and shows that the dots 20a, 20b, 20c and 20d were interlinked with one another so as to form a continuous line 60. Line 60 had a more uniform width than line 54 shown in FIG. 3B but, was still unacceptably wavy as can be seen by the included cusps 62 on line 60. Cusps 62 produced areas of reduced width, such as the area indicated at 64, on line 60. These areas of reduced width could have an adverse effect on the sealing capabilities of the viscous material.

### Example 4

The results of Example 4 are illustrated in FIGS. 5A and 5B. In Example 4, dots 20a, 20b, 20c and 20d were spaced apart from one another by a spacing d₄ indicated between the centers of dots 20a and 20b in FIG. 5A. The value of d₄ was about 0.64 mm, which was less than the previously discussed spacings d₁, d₂ and d₃. As shown in FIGS. 5B and 5C, the contacting engagement of substrate 50 with the dots 20a, 20b, 20c and 20d caused these dots to flow together with one another so as to form a continuous line 66 of viscous material having a substantially uniform width 68. Line 66 had a length 69 (FIG. 5B) and a thickness 71 (FIG. 5C).

During the lamination process, the line 66 of viscous material bonded the components 50 and 24 to one another. Thickness 71 of line 66 was relatively thin, which is an advantage as compared to a relatively thick line, since a relatively thin line of viscous material between two components, such as components 24 and 50, will provide greater resistance to the diffusion of water, oxygen and other unwanted substances through the viscous material. This is particularly important in applications where the viscous material is used to form a seal, such as in the manufacture of OLED Display Panels. Also, less material is used with a relatively thin line as compared to a relatively thick line, which is an advantage in all applications.

Examples 1-4, that used spacings d₁, d₂, d₃ and d₄, between adjacent ones of the dots 20, illustrate the manner in which the optimum spacing between adjacent ones of the dots, for a given viscous material having a predetermined size and shape of dispensed material, can be selected.

### Example 5

The results of Example 5 are illustrated in FIGS. 6A and 6B. In Example 5, a first plurality 70 of dots 20, with the individual dots 20 being spaced apart from one another, and a second plurality 72 of dots 20, again with the individual ones of the dots 20 being spaced apart from one another, were deposited onto surface 25 of substrate 24. FIG. 6B illustrates the shape of the viscous material after the second component 50 had been brought into contacting engagement with the dots 20 on component 24. As shown in FIG. 6B, the dots 20 of the first plurality 70 of dots 20 were interlinked with one another so as to form a first continuous line 74, having a substantially uniform width 76. Similarly, the individual dots 20 of the second 72 plurality of dots 20, were interlinked with one another so as to form a second continuous line 78, having a substantially uniform width 80. As shown in FIG. 6B, lines 74 and 78 were angled relative to one another by an angle 84 that was about 90°. As further shown in FIG. 6B, lines 74 and 78 intersected one another in such a manner that a substantially well defined, and relatively small, inside fillet radius 82 existed at the intersection of lines 74 and 78. This can be advantageous in the display panel industry, since small radii, such as radius 82, can prevent the loss of display panel surface area.

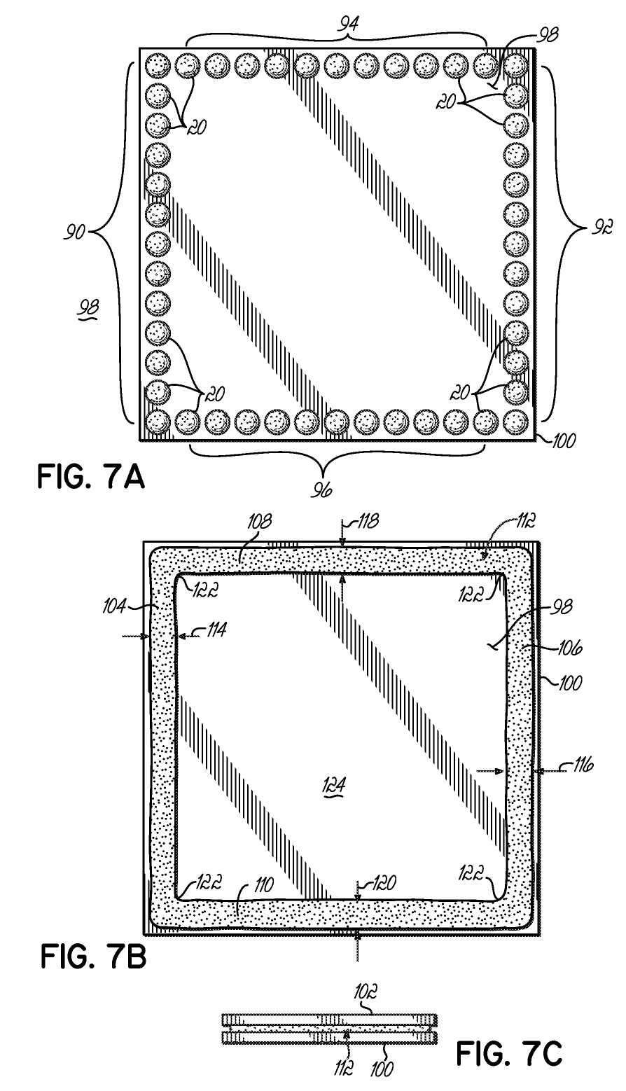

The methodology of the present invention also can be utilized to form a seal of viscous material between two substrates, as illustrated in FIGS. 7A, 7B and 7C. As shown in FIG. 7A, first 90, second 92, third 94 and fourth 96 pluralities of dots, such as dots 20, can be deposited onto a surface of a first component of an electronic assembly, such as surface 98 of component 100. As shown in FIG. 7A, each dot 20 is spaced apart from every other dot 20. Additionally, the dots 20 of the first plurality 90 are aligned with one another, as are the dots within the second 92, third 94 and fourth 96 pluralities of dots 20.

A second component 102 of an electronic assembly is brought into contact with the dots 20 of each of the pluralities 90, 92, 94 and 96 of dots 20, causing the dots 20 of individual ones of pluralities 90, 92, 94 and 96 to merge together to form, respectively, first 104, second 106, third 108 and fourth 110 continuous lines of the viscous material. Also, the lines 104, 106, 108 and 110 are interlinked with one another to form a seal 112 of the viscous material between the components 100 and 102 of an electronic assembly. In the illustrative embodiment, lines 104 and 106 are substantially parallel with one another and each are substantially perpendicular to line 108 and line 110, such that seal 112 has a substantially parallelogram shape, that can be either a square or a rectangular shape. Since any combination of straight and curved lines can be used to form a seal using the methodology of the present invention, the formed seals can also have virtually any other shape, including, but not limited to, other polygonal shapes, round, oblong or irregular shapes, within the scope of the present invention.

Lines 104, 106, 108 and 110 have widths 114, 116, 118 and 120, respectively. Each of the widths 114, 116, 118 and 120 are substantially uniform. Also, as shown in FIG. 7B, the lines 104, 106, 108 and 110 intersect one another in such a manner that a substantially well defined, and relatively small, inside fillet radius 122 exists at the intersection of each pair of the lines 104, 106, 108 and 110.

Seal 112 surrounds an interior area 124 of substrate 100 and a corresponding area (not shown) of substrate 102. Accordingly, the diffusion of water, oxygen and other unwanted substances into the interior area 124 of substrate 100, and the corresponding area of substrate 102, is maintained at an acceptable level.

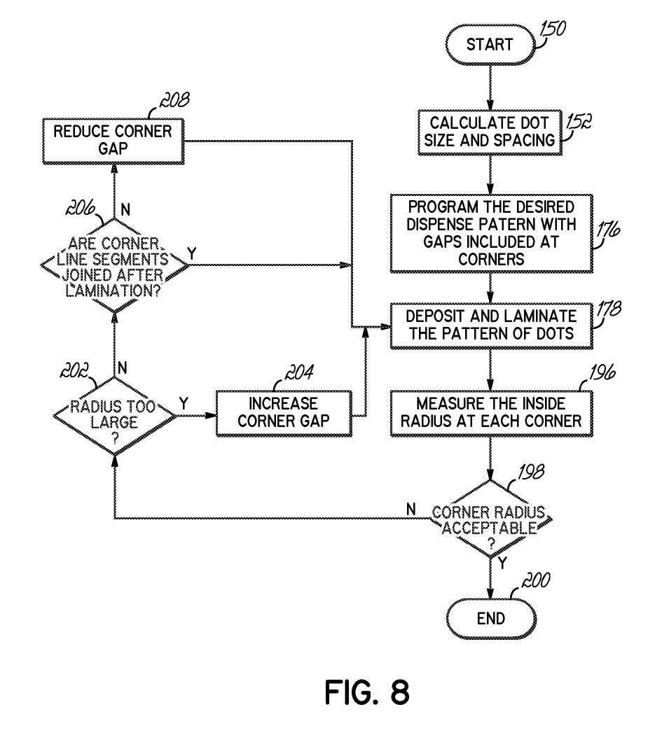

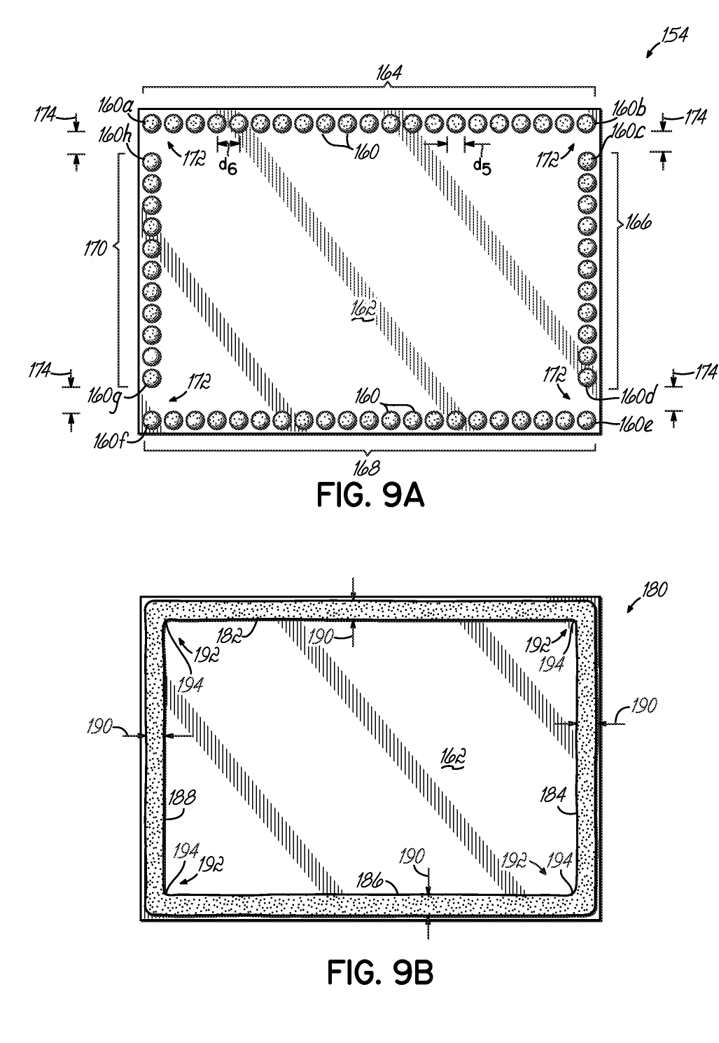

In order to achieve acceptable results concerning the inside radii formed in a seal of viscous material having a substantially parallelogram shape, over a wide range of applications, it can be advantageous to leave gaps in the corners of the pattern of dots of viscous material to be deposited to create the seal of viscous material. This methodology is illustrated in conjunction with FIGS. 8, 9A and 9B. When this methodology is started, indicated at 150, the size of the dots and the spacing of the dots, also referred to as pitch, are calculated as indicated at 152, to provide the desired line widths of the pattern of viscous material formed after lamination. This is illustrated further with reference to FIGS. 9A and 9B. FIG. 9A illustrates a pattern 154 of dots 160, after being deposited onto a substrate 162. Dots 160 can be shaped as discussed previously with respect to dots 20. In the illustrative embodiment, the dots 160 have a diameter d₅ and are spaced apart, center-to-center, by a distance d₆. The pattern 154 includes sets 164, 166, 168 and 170 of dots 160. End points, or end ones of dots 160, are selected for each of the sets 164, 166, 168 and 170 of dots 160 to achieve the desired pattern of viscous material to be formed. These endpoints are designated 160a, 160b for set 164; 160c, 160d for set 166; 160e, 160f for set 168; and 160g, 160h for set 170.

The pattern 154 of dots 160 includes a plurality of corners 172 between adjacent pairs of the sets 164, 166, 168 and 170 of dots 160. For example, one of the corners 172 exists between sets 164 and 166, another exists between sets 164 and 170, etc. The pattern 154 of dots 160 is further defined with gaps 174 (FIG. 9A), at each of the corners 172, between adjacent endpoints of adjacent ones of the sets 164, 166, 168 and 170. For example, one of the corners 172 exists between endpoint 160b of set 164 and endpoint 160c of set 166. The magnitude of gaps 174 can vary with application. In one embodiment, the magnitude of gaps 174 can be about the same as the magnitude of diameter d₅ of dots 160. The pattern 154 of dots 160 is then programmed, as indicated at 176 in FIG. 8, using a controller such as controller 16 discussed previously.

The pattern 154 of dots 160 is then deposited onto a surface of substrate 162, a second substrate (not shown) is brought into contact with dots 160 and the first substrate 162, second substrate and dots 160 are laminated, as indicated at 178 in FIG. 8. This forms a pattern 180, which can be a seal, of viscous material between the first 162 and second substrates. The pattern 180 of viscous material includes continuous line segments 182, 184, 186 and 188, each having a substantially uniform width 190, that are interconnected with one another as shown in FIG. 9B. Pattern 180 includes a plurality of corners 192 at each interconnected pair of line segments 182, 184, 186 and 188. Each corner has an inside radius 194.

The radii 194 are measured, as indicated at 196 in FIG. 8, and it is determined if the shape and size of radii 194 are acceptable, as indicated at 198 in FIG. 8. If radii 194 are acceptable, this setup methodology is ended, indicated at 200 in FIG. 8, and the depositing of patterns 154 of dots 160 onto substrate 162 can be continued.

If the radii 194 are too large, the magnitude of gaps 174 (FIG. 9A) is increased as indicated at 202 and 204 in FIG. 8 and steps 178, 196 and 198 are repeated. If the radii 194 are not too large, but are unacceptable because adjacent pairs of line segments 182, 184, 186 and 188 are not interconnected to one another, the magnitude of gaps 174 are reduced as indicated at 206 and 208 in FIG. 8. Steps 178, 196 and 198 are then repeated.

During production cycles of dispensing dots of viscous material to create seals having interconnected, continuous line segments of the viscous material, as discussed previously, various factors can cause a variation in the mass flow rate of the viscous material being dispensed that can have an undesirable effect on the seal that is formed. These factors can include batch-to-batch variations in the fluid properties of the viscous material, an increase in fluid viscosity due to excessive “pot life”, and wear in the fluid dispensing equipment such as a jet dispenser. The methodology according to the principles of the present invention includes steps to correct for these variations. This can be illustrated with reference to FIGS. 9A, 10, 11, 12A and 12B.

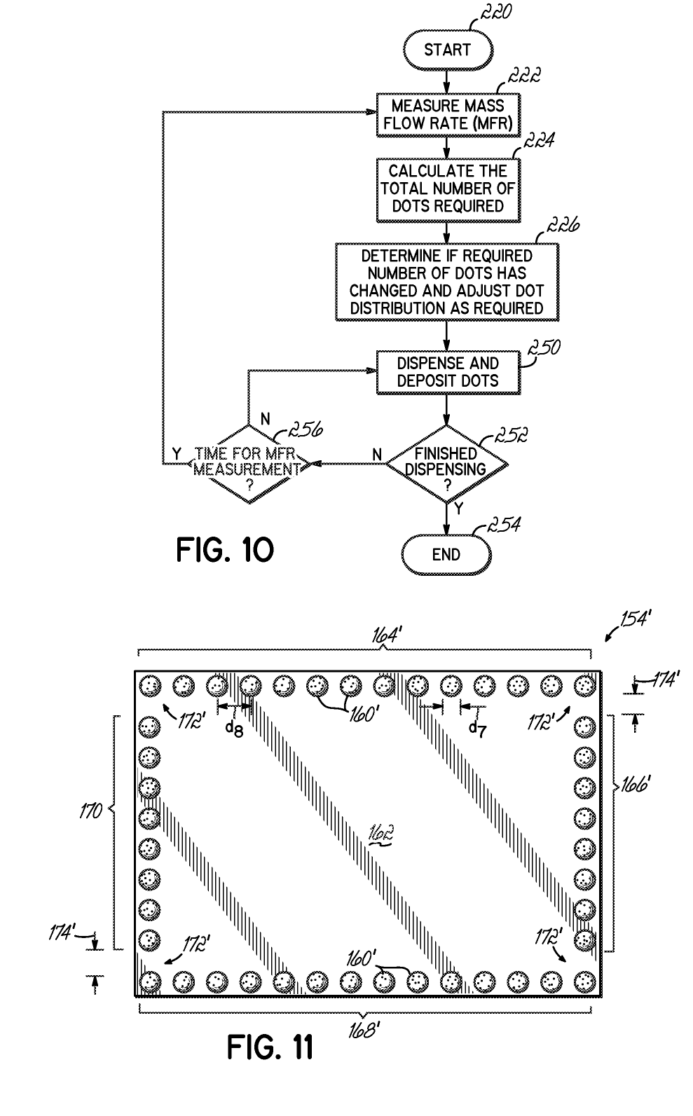

As shown in FIG. 10, at the start 220 of these steps, the mass flow rate of the viscous material being dispensed is measured as indicated at 222, which determines the mass of the individual dots being dispensed. The number of dots required to maintain the total weight of the pattern of dots being dispensed is then calculated as indicated at 224, as compared to the total weight of dots being dispensed initially, for example in the pattern 154 of dots 160 shown in FIG. 9A. It is then determined if the number of dots required to maintain the total weight of the pattern has changed, as indicated at 226. If so, the distribution of dots within the pattern of dots to be dispensed and deposited onto a substrate is adjusted as required.

For example, if the required number of dots has decreased due to an increase in the mass and size of the dots, dots are subtracted from the pattern of dots such as pattern 154. This is illustrated by comparing FIG. 11 to FIG. 9A. In FIG. 11, a revised pattern 154′ of dots 160′ are dispensed onto substrate 162. Dots 160′ have a diameter d₇ that is greater than the diameter d₅ (FIG. 9A) of dots 160, and have a spacing d₈ that is greater than the spacing or pitch d₆ of dots 160 shown in FIG. 9A. Also, pattern 154′ includes corners 172′ and gaps 174′ that exist at each of the corners 172′. Gaps 174′ are larger than gaps 174 of pattern 154. Dots are subtracted from pattern 154, resulting in pattern 154′, in a manner that results in the least impact on the width of the line segments and inside radii of the pattern of viscous material to be formed. In one embodiment, this subtraction of dots is done in proportion to the number of dots originally included in each set or line segment of dots in the pattern, starting with the longest set of dots. Accordingly, for the example illustrated in FIGS. 9A and 11, dots 160 would be subtracted initially from either set 164 or set 168, since they are the longest, and then from either set 166 or set 170 of dots 160.

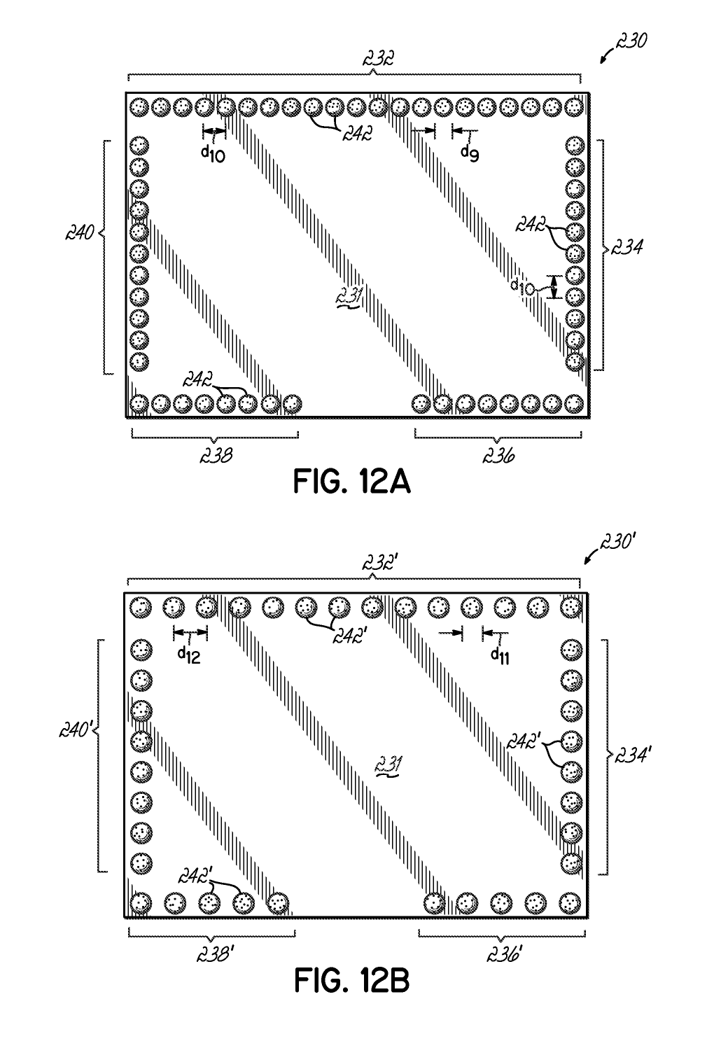

This methodology is also illustrated in FIGS. 12A and 12B with respect to five-segment patterns of dots 230 and 230′ that are deposited onto a substrate 231, as compared to the four-segment patterns 154 and 154′ shown in FIGS. 9A and 11, respectively. Pattern 230 includes sets 232, 234, 236, 238 and 240 of dots 242. Each dot 242 has a diameter d₉ and the dots 242 are spaced, center-to-center, by a distance d₁₀. As with the previous example, the mass flow rate of viscous material being dispensed has increased, so the diameter d₁₁ of dots 242′ in pattern 230′ (FIG. 10B) is greater than diameter d₉ of dots 242, and a center-to-center spacing d₁₂ of dots 242′ is greater than the corresponding spacing d₁₀ of dots 242. Using the previously discussed method of subtracting dots from pattern 230 to maintain the total weight of viscous material dispensed, dots would initially be subtracted from set 232 since it is the longest within pattern 230. Dots would next be subtracted from either set 234 or 240, having intermediate lengths, and finally from either sets 236 or 238 that have the shortest lengths within pattern 230. In some instances, in either the four or five-segments examples discussed, it may not be necessary to subtract dots from each of the sets of dots to maintain the total weight of viscous material dispensed. However, the approach would be the same, i.e., dots would be subtracted initially from the set of dots having the largest length.

Once the pattern of dots has been adjusted as required, the dispensing and depositing of dots is continued as indicated at 250 in FIG. 10. After some predetermined period of time, if dispensing of viscous material is finished, the production cycle is ended, as indicated at 252 and 254. If it is not time to finish dispensing, it is determined if it is time for another measurement of the mass flow rate of the viscous material, as indicated at 256. If not, steps 250 and 252 are repeated. If it is time to take another measurement, steps 222, 224, 226, 250 and 252 are repeated.

While the foregoing description has set forth preferred embodiments of the present invention in particular detail, it must be understood that numerous modifications, substitutions and changes can be undertaken without departing from the true spirit and scope of the present invention as defined by the ensuing claims. The invention is therefore not limited to specific embodiments as described but is only limited as defined by the following claims.

What is claimed is:

1. A method of forming at least one continuous line of viscous material between two components of an electronic assembly forming two substrates, comprising the steps of:
depositing a plurality of spaced apart dots of the viscous material onto a surface of a first one of the substrates;
bringing a second one of the substrates into contact with the dots causing the dots to merge together to form at least one continuous line of the viscous material between the two substrates.

2. A method as recited in claim 1, wherein said step of depositing a plurality of spaced apart dots onto the surface of the first one of the substrates further comprises:
jetting the plurality of spaced apart dots onto the surface of the first one of the substrates.

3. A method as recited in claim 1, wherein said step of depositing the plurality of spaced apart dots onto the surface of the first one of the substrates further comprises:
stenciling the plurality of spaced apart dots onto the surface of the first one of the substrates.

4. A method as recited in claim 1, wherein said step of depositing the plurality of spaced apart dots onto the surface of the first one of the substrates further comprises:
pin transferring the plurality of spaced apart dots onto the surface of the first one of the substrates.

5. A method as recited in claim 1, wherein said step of depositing the plurality of spaced apart dots onto the surface of the first one of the substrates further comprises:
needle dispensing the plurality of spaced apart dots onto the surface of the first one of the substrates.

6. A method as recited in claim 1, further comprising:
selecting a predetermined spacing between adjacent ones of the dots on the surface of the first one of the substrates so that said step of bringing the second one of the substrates into contact with the dots causes the dots to merge together to create at least one continuous line of the viscous material between the two substrates.

7. A method as recited in claim 6, further comprising:
creating a substantially uniform width of the continuous line of the viscous material.

8. A method as recited in claim 1, further comprising:
forming a first continuous line of the viscous material between the two substrates; and
forming a second continuous line of the viscous material between the two substrates.

9. A method as recited in claim 8, further comprising:
forming the second continuous line substantially perpendicular to the first continuous line.

10. A method as recited in claim 9, further comprising:
forming a substantially uniform inside fillet radius of the viscous material between the first and second continuous lines of the viscous material.

11. A method as recited in claim 8, wherein:
the first continuous line of viscous material has a substantially uniform first width and the second continuous line of the viscous material has a substantially uniform second width.

12. A method as recited in claim 8, wherein the step of forming a first continuous line further comprises the step of:
depositing a first plurality of dots onto the surface of the first one of the substrates so that individual ones of the first plurality of dots are spaced apart from one another and are aligned with one another.

13. A method as recited in claim 12, wherein the step of forming the second continuous line further comprises the step of:
depositing a second plurality of the dots onto the surface of the first one of the substrates so that individual ones of the second plurality of dots are spaced apart from one another and are aligned with one another.

14. A method as recited in claim 13, wherein the step of bringing the second one of the substrates into contact with the dots further comprises the step of:
bringing the second one of the substrates into contact with the first and second pluralities of dots causing the dots of the first plurality to merge together to form the first continuous line of the viscous material between the two substrates and causing the dots of the second plurality to merge together to form the second continuous line of the viscous material between the two components.

15. A method as recited in claim 1, further comprising:
laminating the two substrates and the viscous material disposed between the substrates.

16. A method of forming a seal of viscous material between two components of an electronic assembly forming two substrates, comprising:
depositing first, second, third and fourth pluralities of dots of the viscous material onto a surface of a first one of the substrates so that each of the dots, of the first, second, third and fourth pluralities of dots, are spaced apart from every other dot of the viscous material;
bringing a second one of the substrates into contact with the dots of the viscous material of the first, second, third and fourth pluralities of dots, said step of bringing further comprising:
forming first and second continuous lines of the viscous material from the first and second pluralities of dots, respectively, the first and second lines being spaced apart from one another and substantially parallel with one another;
forming third and fourth continuous lines of the viscous material from the third and fourth pluralities of dots, respectively, the third and fourth lines being spaced apart from one another and substantially parallel with one another, each of the third and fourth lines being substantially perpendicular with the first and second lines; and
interconnecting the first, second, third and fourth lines with one another to create a substantially parallelogram-shaped seal of the viscous material between the two components.

17. A method as recited in claim 16, wherein said step of depositing the first, second, third and fourth pluralities of dots onto the surface of the first one of the substrates further comprises:
jetting the first, second, third and fourth pluralities of the dots onto the surface of the first substrate so that each of the dots, of the first, second, third and fourth pluralities of dots, are spaced apart from every other dot.

18. A method of forming a seal of viscous material between two components of an electronic assembly forming two substrates, comprising the steps of:
depositing a plurality of dots of the viscous material onto a surface of a first one of the substrates so that each of the dots is spaced apart from every other dot;
bringing a second one of the substrates into contact with the dots; said step of bringing further comprising:
forming at least one continuous line of the viscous material from the plurality of dots;
surrounding an interior area of each of the substrates with the at least one continuous line of the viscous material to create a seal of the viscous material between the two substrates.

19. A method of forming a pattern of viscous material between two components of an electronic assembly forming two substrates, the pattern including a plurality of continuous line segments of the viscous material and corners at each interconnected pair of line segments, said method comprising the steps of:
depositing a pattern of spaced apart dots of the viscous material onto a surface of one of the substrates, the pattern of dots including multiple sets of aligned ones of the dots and a plurality of corners, each of the corners being formed by an adjacent pair of the sets of dots, the number of sets of aligned ones of the dots corresponding to the number of continuous line segments of the pattern of viscous material to be formed, the step of depositing comprising:
selecting a predetermined size of individual ones of the dots to achieve a substantially uniform width for each of the continuous line segments of the pattern of viscous material to be formed;
selecting a pair of end points for each of the sets of aligned ones of the dots to be deposited;
leaving a gap at each corner of the pattern of dots to be deposited between one of the endpoints of a first one of the adjacent pair of sets of dots and an adjacent one of the endpoints of a second one of the adjacent pair of sets of dots, for each adjacent pair of the sets of dots; and
bringing a second one of the substrates into contact with the dots to form the pattern of continuous line segments of the viscous material.

20. A method as recited in claim 19, further comprising:
programming a controller with the pattern of dots to be deposited.

21. A method as recited in claim 19, further comprising:
laminating the two substrates and the pattern of viscous material disposed between the substrates.

22. A method as recited in claim 21, further comprising:
determining if the line segments of the pattern of viscous material are interconnected with one another to form the corners of the pattern, the corners having inside radii;
measuring the inside radii of the corners of intersecting ones of the line segments of the viscous material;
adjusting the gaps within the pattern of dots to be deposited as required to achieve the desired pattern of viscous material.

23. A method as recited in claim 22, further comprising:
reducing the gaps within the pattern of dots to be deposited if the adjacent pairs of line segments do not join to form the corners within the pattern of viscous material.

24. A method as recited in claim 22, further comprising:
increasing the gaps within the pattern of dots to be deposited if the radii of the corners within the pattern of viscous material are too large.

25. A method as recited in claim 19, further comprising:
measuring the mass flow rate of the dots of the viscous material being deposited;
calculating the total number of dots required within the pattern of dots to maintain the total weight of dots within the pattern of dots to be deposited;
adjusting the number and distribution of dots within the pattern of dots if required to maintain the total weight of dots within the pattern of dots to be deposited.

26. A method as recited in claim 25, further comprising:
decreasing the number of dots within at least some of the sets of aligned ones of the dots, in proportion to the distances between the endpoints of each of the sets of dots, starting with the set of dots having the greatest distance between the endpoints, if the number of dots required to maintain the total weight of dots to be deposited has decreased relative to the number of dots required in the step of depositing the pattern of spaced apart dots.

27. A method as recited in claim 25, further comprising:
increasing the number of dots within at least some of the sets of aligned ones of the dots, in proportion to the distances between the endpoints of each of the sets of dots, starting with the set of dots having the greatest distance between the endpoints, if the number of dots required to maintain the total weight of dots to be deposited has increased relative to the number of dots required in the step of depositing the pattern of spaced apart dots.

28. A method as recited in claim 25, further comprising:
programming a controller with the pattern of dots to be deposited.

29. A method as recited in claim 25, further comprising:
laminating the two substrates and the pattern of viscous material disposed between the substrates.
